(19) United States
(12) Patent Application Publication
(10) Pub. No.: US 2022/0128645 A1
(43) Pub. Date: Apr. 28, 2022

(54) METHOD AND SYSTEM FOR DETERMINING THE POSITION OF A FORMWORK

(71) Applicant: Umdasch Group NewCon GmbH, Amstetten (AT)

(72) Inventors: Denis Robin CVETKOVIC, Hausmening (AT); Florian DOBER, Neufurth (AT); Martin BRANDL, Maria Taferl (AT); Lucas Johannes WINTER, Wien (AT)

(21) Appl. No.: 17/436,178

(22) PCT Filed: Mar. 5, 2020
(86) PCT No.: PCT/EP2020/055782

§ 371 Date: Sep. 3, 2021

(30) Foreign Application Priority Data
Mar. 5, 2019 (EP) 19160866.0

(51) Int. Cl. G01S 5/02; E04G 11/08

(52) U.S. Cl. CPC G01S 5/0269; E04G 11/08

(57) ABSTRACT

The application relates to a method and a system for determining the position of a fitted formwork, including: emitting a locating signal from the fitted formwork; receiving the emitted locating signal using a receiver at at least one reference point; determining a distance between the fitted formwork and the at least one reference point on the basis of the locating signal received; determining a fitting position, compatible with the distance determined, of the fitted formwork on at least one existing formwork; and storing the fitting position determined as the position of the fitted formwork.

The invention relates to a method and a system for determining the position of a formwork fitted to at least one existing formwork.

In this context, a formwork is a single element, which is usually flat on at least one side, for producing a hollow mould for casting concrete parts. Such an element usually comprises a formwork plate or a formwork panel and can optionally comprise a frame. The formwork panel is regularly made of wood, such as plywood or solid wood for example, and can optionally be coated or sealed. The invention is applicable to any type of formwork, e.g., wall formworks and/or ceiling formworks and/or climbing formworks.

Such formworks are usually reused multiple times, often also on the same construction site. In addition, depending on the requirements of the concrete parts to be cast, formworks of different sizes and thicknesses are used.

In order to make optimal use of the existing formworks, it is important to track which formwork is used when and where. On the basis of this information and/or a specified forming time or a defined construction process, a form removal time for each formwork can be determined individually. Thereby, the information is available concerning which formwork with which dimensions along with where and when it is free for reuse. This allows an overview of the existing formworks and an optimization of the total necessary formworks (i.e., the number) as well as the transport routes of the individual formworks. Furthermore, it is also favourable to track the positions of the formworks during interim storage. From this, conclusions can be drawn for waste management, logistics and/or construction site operations, and it is possible to determine where there is currently space for setting up a formwork.

For the determining the position or locating the formwork, an accuracy is required, which can be achieved, for example, with UWB technology (ultra-wideband). Signals with a bandwidth of at least 500 MHz are used, and a relatively low transmission power can be used in order not to interfere with frequency ranges that are already allocated (e.g., 0.5 mW/−41.3 dBm/MHz). These frequency ranges allow centimetre-accurate indoor localizations and integrated data communication. With this technology, receivers (or “anchors”) for locating signals are positioned at a plurality of reference points around a desired area. The receivers receive locating signals from transmitters (e.g., “tags”, “sensors” or “transmitters”) and forward the received information (e.g., time stamp, signal strength, data content) to a central unit (or “server”). This forwarding can take place in real-time (RT) or near real-time (NRT). In this case, this is referred to as a real-time locating system (RTLS). The position determination is based on the determination of the distances of the transmitter to a plurality of receivers; specifically, the transit time between the transmitter and at least three receivers is determined, and, on the basis of this information provided by the receivers, the position of the transmitter is determined together with the known positions of the receivers by means of trilateration. For example, the transmitters can be battery-operated. They essentially transmit at least one identification (ID) and one timestamp (“timestamp”) to the receiver. An exemplary application of this positioning technology for the dynamic position determination of persons, e.g., on a playing field, is described in WO 2013/167702 A1.

However, for the application of the position determination of formworks on a construction site, the technology explained above has the disadvantage that a line of sight (LoS) between the transmitter and at least three receivers is required. A line of sight can be understood not only as a direct optical line of sight between receiver and transmitter, but also as an interruption-free or low-interruption transmission of electromagnetic signals, data, etc. Due to the essentially plate-shaped geometry of formworks and their opposite/mirrored arrangement during use, the simultaneous use of a plurality of formworks (e.g., more than ten) almost inevitably leads to interruptions of these lines of sight and signal disturbances, in particular, if the receivers are to be located outside the construction site (for example, at the edge or above). In principle, this problem could be solved by arranging three receivers in each room to be built. However, the associated effort (equipment costs and setup effort) makes this solution impractical.

Another purpose is pursued by EP 3 351 699 A1. The system and method shown in it is used to automate a crane control system during the construction of a building made of prefabricated wall elements. The target position of a new wall element is determined based on measurements of the existing building and the new wall element. The actual position of the new wall element is determined and continuously monitored with GNSS receivers on the wall element itself or on a crane gripper or with measuring devices and corresponding reflectors on the new wall element.

The US 2005/0107934 A1 only generally concerns a position determination on a construction site. The positions of different monitored units are determined by GNSS.

It is an object of the invention to eliminate or at least reduce at least individual disadvantages of the prior art.

The invention provides for a method of the type mentioned above, comprising:

sending a locating signal from the fitted formwork (i.e., from a tag or transmitter of this formwork);

receiving the transmitted locating signal with a receiver at at least one reference point;

determining a distance between the fitted formwork and at least one reference point based on the received locating signal;

determining a fitting position of the fitted formwork on at least one existing formwork compatible with the determined distance (wherein the position(s) of at least one existing formwork is/are known); and

saving the determined fitting position as the position of the fitted formwork.

In addition, the invention provides for a system of the aforementioned type, comprising:

a fitted formwork with a transmitter for a locating signal,

at least one reference point with a receiver for a locating signal,

a distance detection unit set up to determine a distance between the fitted formwork and at least one reference point based on a locating signal sent by the transmitter and received by the receiver;

a position database with stored positions of at least one existing formwork; and

an adjustment unit set up to determine a distance compatible with a distance determined by the distance determination unit of the fitted formwork on an existing formwork and to store the determined fitting positions in the position database as the position of the fitted formwork.

When determining the distance between the fitted formwork and the reference point, the distance between the transmitter or tag on the formwork and one or a plurality of receivers or anchors is specifically determined. Naturally, this determination is not based exclusively on the received locating signal, but also takes into account, for example, the position of the receiver and the time of receipt of the locating signal. Depending on the circumstances, one or a plurality or all fitting positions of the fitted formwork on the at least one existing formwork can be determined. Determining a fitting position requires knowledge of the geometry of the two formworks. In the simplest case, a uniform, predetermined geometry of all formworks can be assumed. If exactly one compatible fitting position has been determined, this fitting position is stored as the position of the fitted formwork. Otherwise, a selection can be made based on a sequence of fitting positions, for example, based on an associated inaccuracy or an associated probability.

Determining the fitting position can comprise, for example:

determining all possible fitting positions of the fitted formwork on the at least one existing formwork;

determining the respective associated distance of the determined possible fitting positions to the at least one reference point;

determining those fitting positions as compatible with the determined distance whose associated distance is within a tolerance range around the determined distance. As a tolerance range, in particular, a distance range can be used, the width of which essentially corresponds to the inaccuracy of the positioning, e.g., with a width between 5 cm and 30 cm or of about 10 cm or of about 20 cm.

As an alternative to determining all fitting positions of the fitted formwork on the at least one existing formwork, it is also conceivable that only the fitting positions within the tolerance range of the determined distance are determined. Especially with a very large number of existing formworks, methods can be simplified and accelerated with this method.

In addition, determining the fitting position can comprise: Limiting the possible fitting positions based on a local zone boundary. The local zone boundary forms a boundary condition for possible fitting positions. This means that only those fitting positions are possible in which the formwork is positioned within the locally limited area. The construction site size and position or generally the boundary or dimensions of the construction site can be used as such an area limit, for example. In this example, only such fitting positions would be considered in which the formwork remains on the construction site.

In this context, determining the fitting position may also comprise: Limiting the possible fitting positions on the basis of orientation information regarding the fitted formwork. The orientation information can be obtained, for example, by means of a magnetometer or a compass, each of which can be fixed to the fitted formwork. If orientation information is available, possible fitting positions in which the hypothetical orientation of the formwork differs from the actual situation determined on the basis of the orientation information can in principle (i.e., determined according to one of the above-mentioned methods) be discarded. A limit value or tolerance range can be used, which is based on the inaccuracy of the orientation information, for example a tolerance range of 10° for the horizontal orientation and a tolerance range of 20° for the vertical orientation.

The fitted formwork in the present system can optionally have an orientation sensor, wherein the orientation sensor is connected to the transmitter for the locating signal. As a result, the orientation information can be read from the orientation sensor and transmitted to the receiver via the transmitter. Sufficient information is then available on the receiver to determine both the orientation as well as—possibly depending on the orientation—the position of the fitted formwork.

In a further embodiment, the transmitter or tag of the fitted formwork can also comprise a 3D gyrometer (3D gyroscope), 3D magnetometer and/or a 3D accelerometer (acceleration sensor). Formworks are essentially supplied with certain widths and heights. Examples of such widths include 30 cm, 45 cm, 60 cm, 90 cm and 135 cm. Examples of such heights include 135 cm, 270 cm and 330 cm. On a construction site, it may well occur that two or a plurality of formworks are used to depict a different formwork height or width. For example, 45 cm wide and a 90 cm wide formwork could be combined to form a 135 cm wide formwork. In order to make this system usable for the application according to the invention, not only the two-dimensional orientation (magnetometer), but also the orientation in three-dimensional space can be determined. If a formwork is now rotated to depict the width as height and height as width, the three-dimensional orientation can be detected in order to be able to determine the fitting positions more precisely.

Such a orientation detection in three-dimensional space also offers the positive effect that a formwork lying horizontally or on a stack can also be detected. Horizontal formwork is basically equivalent to stationary, i.e., inactive formworks. As soon as a resting position is detected, it can be calculated and compared with the digital model whether the formwork is still in use or can be removed. If a flat horizontal formwork is detected, it can be set to inactive in the digital system. The position of the inactive formwork is also determined by the geometry data of the formwork. Since the exact position determination is not primarily important for horizontal formworks and horizontally lying formworks are visually easily detectable, an approximate position determination is sufficient, in particular, since flat horizontal formworks often comprise no visual contact due to their low position (Line of Sight; LoS) to the receivers, so that, from the point in time when there is contact with no receiver, a high probability can be associated with the formwork that it is in a resting position. In the case of delivered containers (e.g., formworks stacked on top of each other), the topmost formwork can be detected in a resting position. The horizontal formworks below can only be detected with difficulty or not at all, as the line of sight is interrupted by the horizontal formwork. The first formwork must therefore first be lifted off before the horizontal formwork can be detected. An indication of which formworks are also located below on the transmitter or tag of the top formwork lying horizontally. In addition, it would also be conceivable to attach a tag or transmitter to the pallet or container itself, on which information about the formworks is stored. This data can be processed upon delivery and from the time of visual contact to at least one receiver. When stacking the formworks, the formworks that are moved into a resting position can be detected in time. Thus, a probable stacking sequence can be detected and stored in the digital system.

In accordance with an exemplary embodiment of the disclosed method, a locating signal together with a geometry of the fitted formwork and/or with a orientation information from the fitted formwork can be transmitted to a receiver. A definition of the geometry of the formwork can be contained in the locating signal or a reference to one of a plurality of possible specified geometry definitions or an identification of the formwork, from which the geometry can be concluded and which, for example, is linked to a geometry definition.

Accordingly, in the disclosed system, the adjustment unit can be connected to a geometry database with stored formwork geometries of the fitted formwork and at least one existing formwork. The use of such a geometry database is useful if a plurality of different geometries are used.

If no orientation information is available or in order to avoid the transmission of errors in the position determination, the transmitter can be centred on the fitted formwork in the system disclosed here. This means that the transmitter for the locating signal is essentially arranged in the middle of a rear side (i.e., side facing away from the concrete or other building material when pouring) of the formwork and centred at least horizontally on the plane of this lateral surface.

Apart from that, the invention also generally relates to a method for determining the position of a fitted formwork, comprising:

determining the number of reference points with a direct line of sight (i.e., an interference-free or low-interference signal connection, see above) to the fitted formwork;

if the determined number of reference points is less than three or less than two, performing the method according to one of the variants described above.

The conditional application of the method described above allows a differentiation and combination with other, possibly more accurate positioning methods. If such are available, a computationally potentially comparatively more complex and/or inaccurate determination according to the methods presented here can be dispensed with.

If the determined number of reference points is at least three, the position of the fitted formwork can be determined based on the distances to the at least three reference points and associated with a probability of one. As soon as at least three reference points have a line of sight in the sense of an interference-free or low-interference signal connection to the fitted formwork, the position of this formwork can be geometrically determined unambiguously, regardless of the position of other formworks. A position determined in this way can be associated with probability of one to express that no assumptions about the identity, geometry and/or position of the formwork were required to determine the position.

In this context, a reduced probability of less than one can be associated with the position of the fitted formwork determined by one of the methods described above (i.e., on the basis of possible fitting positions), wherein the probability associated with the at least one existing formwork to which the fitted formwork is fitted is taken into account. This allows the uncertainty of the position determined on the basis of a plurality of assumptions to be expressed in a quantitative parameter. Basically, the probability decreases with the number of assumptions made. For example, the probability associated with the existing formwork can be taken into account as a multiplication factor for the new probability. The resulting probability of the position of the fitted formwork can be taken into account when assessing compatibility. For example, if a lower probability limit is exceeded, a warning can be output or a positioning at the relevant position can be discarded (i.e., not stored).

The reduced probability can optionally be determined depending on a deviation of the determined distance from the distance corresponding to the stored fitting position. As a result, the parameter of probability can reflect how great the influence of the assumptions made (fitting position) was compared to the measurement (distance). A larger deviation of the distances thus corresponds to a lower probability. According to a further embodiment variant, the method can be carried out on the basis of a stored installation sequence of a plurality of formworks and the respectively determined positions and/or distances, wherein, in the case of a plurality of possible fitting positions for a fitted formwork, the probability of the possible fitting positions is evaluated on the basis of other chronologically subsequently erected formworks and that of the possible fitting positions is determined as the position of the fitted formwork to which the greatest probability is associated. In this way, after erecting a plurality of formworks, the collected position information of all distance measurements can be combined and can be corrected on this basis the positions of all formworks.

Optionally, determining the fitting position can comprise:

determining a connection geometry for at least two positioning options;

determining the fitting position as part of the position determination of a subsequent formwork, wherein the position of the subsequent formwork is determined at a fitting position compatible with the connection geometry.

In this context, for example, certain forms or special forms can be represented in a simplified way in the digital system. For example, a corner element can have the geometry data of a square in a simplified way. The connection surfaces are decisive for the simplified geometry since the connection surfaces should always be at the edges of the simplified geometry. After other formworks have been placed, the probability of the precise position and orientation of the formwork can be determined more precisely. For example, an arc element could be represented as a square. The position of this simplified square could now be determined. However, there would still be uncertainty as to whether the formwork element was erected correctly. It would be possible, for example, that the arc element was placed mirrored or twisted in the simplified geometry field (square). To prevent this uncertainty, the exact alignment could be displayed using a 3D magnetometer. Other shapes are also possible for such simplified geometries or connection geometries. Examples include rhomboids, parallelograms, deltoids, etc. In addition, a connection geometry can also be three-dimensional. Examples of this are cuboids, wherein the lateral surfaces of such a cuboid of a connection geometry can be congruent with the connection surfaces of a fitted (position-determining) formwork. Basically, a connection geometry is to be seen as a placeholder (block) for a not yet 100% defined position and orientation of a formwork. Furthermore, it would also be conceivable to create a tolerance field via a formwork geometry. This could be represented by a formwork geometry minimum, which has the minimum tolerance geometries, and a formwork geometry maximum, which has the maximum tolerance geometries. A tolerance field would thus form between these two tolerance geometries. The tolerance field represents an uncertainty of the exact position of the spatial boundary surfaces (and thus also of the connection surfaces) at each point of the formwork. Geometrically, the tolerance field corresponds to a shell with a defined thickness (distance between minimum tolerance geometry and maximum tolerance geometry; does not have to be the same everywhere) at which the actual boundary surface is expected. The thickness is inversely proportional to the accuracy with which the position and geometry of the boundary surface is known.

There may also be a plurality of transmitters, tags and/or sensors attached to a formwork. This can be particularly preferred to improve the locating accuracy, since at least two feedbacks can be detected per formwork to be located. Furthermore, the acquisition of at least two transmitters can also provide information about the position of the formwork and serve as a comparison for the recorded position information by the position sensors.

In the case of square formworks, the transmitters, tags and/or sensors are preferably mounted diagonally compared to the areas of the formwork near the corner. This has the advantage that regardless of the rotation of the formwork, a transmitter, tag and/or sensor is always located in an upper part of the formwork.

In addition, it should be mentioned that the connection surfaces, fitting positions, or fitting surfaces of formworks can represent any circumferential surfaces. For example, in those formwork systems that are designed in such a way that formworks can be concreted standing, but also turned. An example is a standing formwork that has been rotated by 90 degrees. The invention is explained below on the basis of particularly preferred exemplary embodiments, to which it should not be limited, and will be further explained with reference to the drawings. In detail, the drawings show:

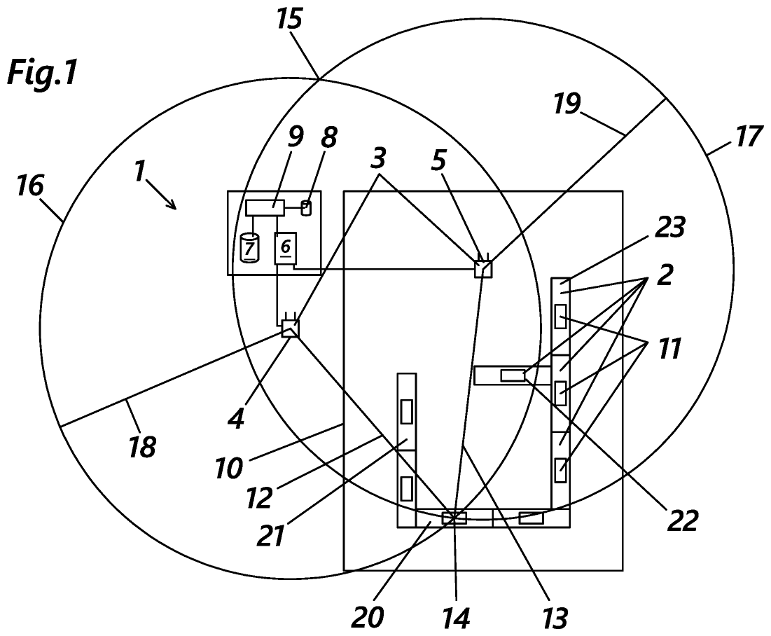

FIG. 1 a schematic ground layout of a system for determining the position of a plurality of formworks on a construction site with two receivers;

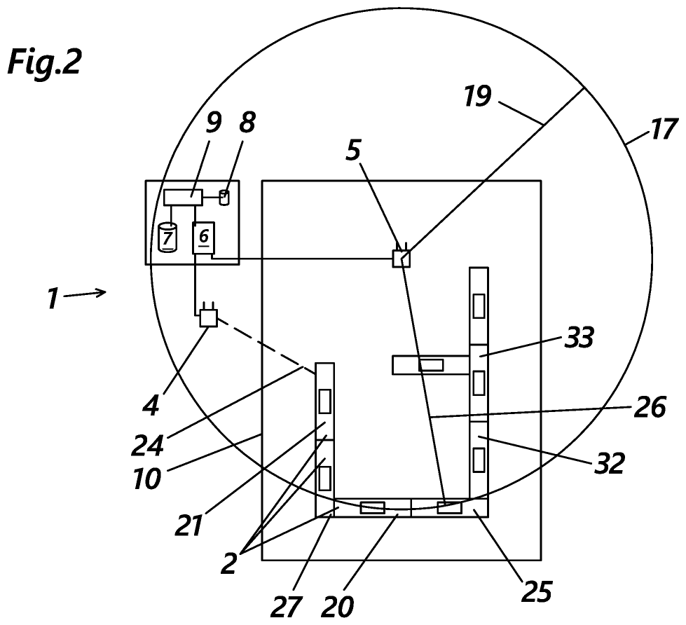

FIG. 2 a view similar to FIG. 1 with a broken line of sight;

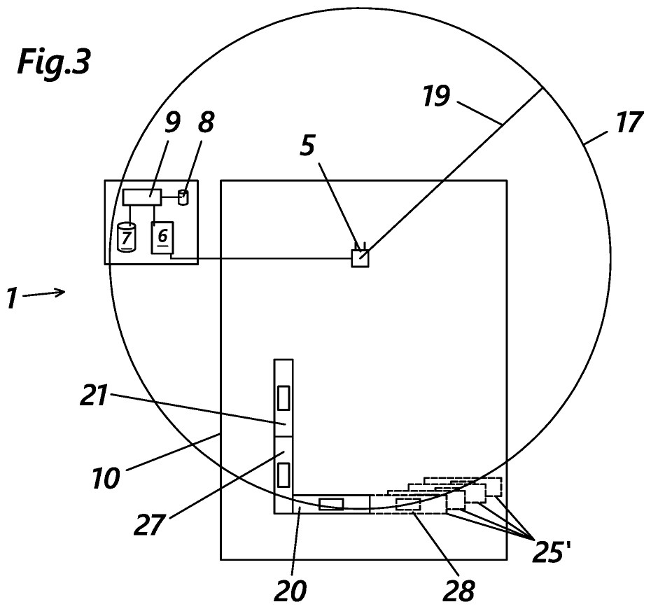

FIG. 3 a schematic ground layout of a simplified system in accordance with FIG. 1 at the point in time of erection to a fourth formwork with a plurality of possible formwork positions;

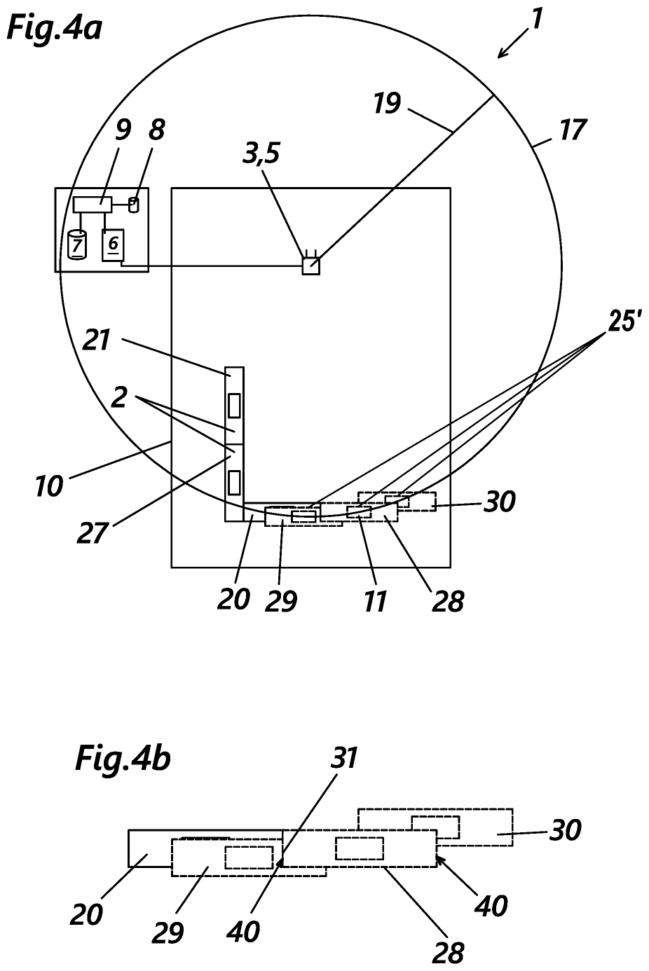

FIGS. 4a and 4b a view similar to FIG. 3 or a detailed view thereof, wherein a fitting position is highlighted among the possible formwork positions;

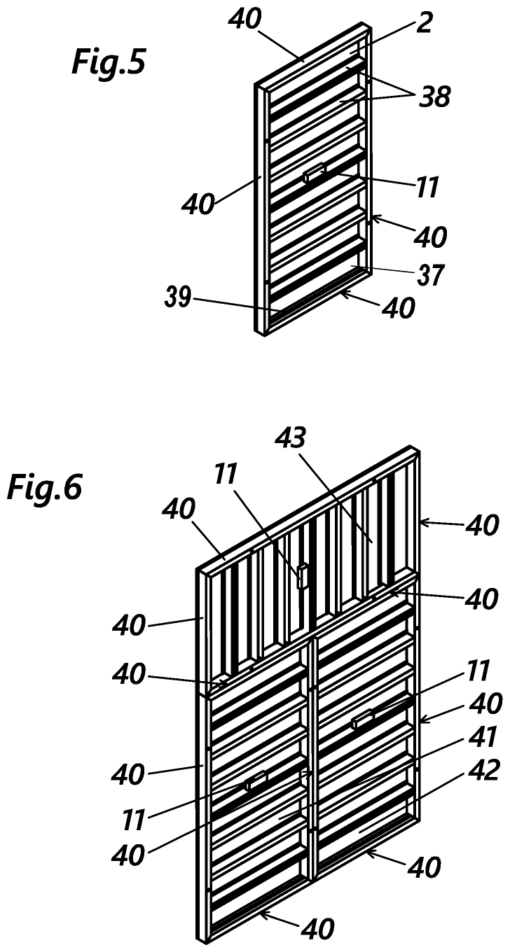

FIG. 5 schematically a formwork element with a transmitter or tag;

FIG. 6 schematically a plurality of formwork elements strung together, each with a transmitter or tag, wherein a formwork element was rotated by 90°;

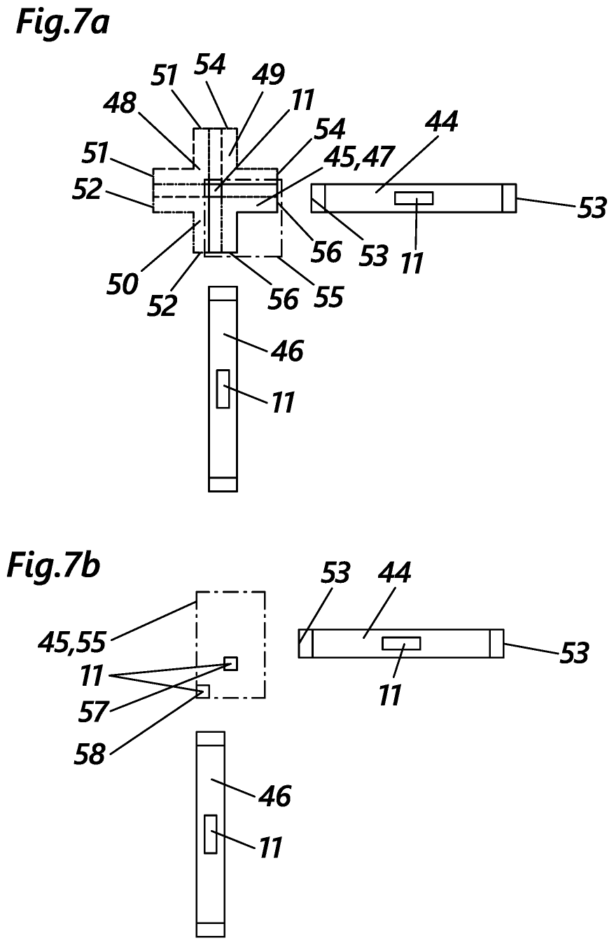

FIG. 7a schematically two formworks with a corner element, wherein the corner element shows four different possible alignment positions;

FIG. 7b schematically, two formworks and a digital connection geometry of a corner element; and

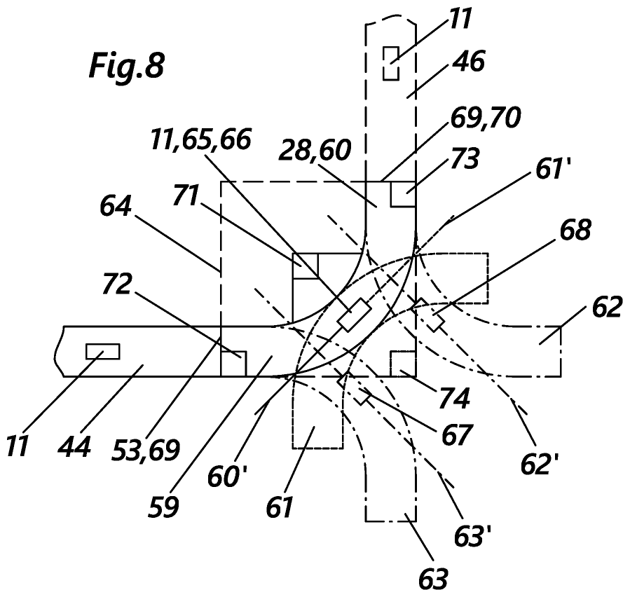

FIG. 8 a view similar to FIG. 7a or 7b, wherein an arc element with four alignment positions and a digital connection geometry is shown.

FIG. 1 shows a system 1 for determining the position of formworks. System 1 comprises a plurality of formworks 2, two reference points 3 each with a receiver 4, 5, a distance determination unit 6, a position database 7, a geometry database 8 and an adjustment unit 9.

System 1 shown is used on a rectangular construction site 10. A plurality of (in this example a total of eight) formworks 2 with partially different dimensions are used. The formworks 2 are each equipped with a transmitter 11 for a locating signal. The positions of the transmitters 11 on the formworks 2 are shown here only roughly schematically. In fact, the transmitters 11 are arranged centred in the middle of the rear side of the respective formwork 2 (cf. FIG. 5). The formworks 2 also have an orientation sensor. The orientation sensors are each connected to the transmitters 11 of the formworks (e.g., integrated as a unit in a housing). During operation, a controller of transmitter 11 reads out orientation information from the connected orientation sensor at regular intervals and transmits the orientation information via transmitter 11 as part of a transmitted locating signal to the receiver(s) 4, 5.

The locating signals sent by the transmitters 11 can be received by the two receivers 4, 5 at the reference points 3. The positions of reference points 3 are known to System 1 and were initialized, for example, during construction using DGNSS or comparable methods. The distance determination unit 6 is connected to both receivers 4, (e.g., via a network connection, such as a mobile data network) and set up to determine a distance between the formworks 2 and the reference points 3 connected to it via a line of sight. The distance is determined on the basis of a locating signal transmitted by the transmitter 11 and received by the receiver 4, 5. For the unambiguous position determination of formworks in two-dimensional space, at least the distances to three reference points are required to perform triangulation without further boundary conditions.

In the example shown in FIG. 1, only two receivers 4, 5 at two reference points 3 are provided. Assuming a known height of the position of the formworks 2 (in a known horizontal plane), the position of a formwork 2 can be limited to two possibilities on the basis of two measured distances 12, 13, as shown by the intersections 14, 15 of the circles 16, 17 of the two reference points 3. The perimeters 16, 17 each have the radius 18, 19 of the distance 12, 13 determined by the relevant reference point 3 on the basis of the locating signal received by the receiver 4, 5. This means that there are two possible positions in the plane, which have the determined distances 12, 13 from both reference points 3. With the additional boundary condition of the local boundary of construction site 10, an intersection point 15 can be excluded as a possible position so that the desired position of formwork 20 can be clearly determined with these assumptions and boundary conditions at intersection 14.

However, in the example shown, only three formworks 21, 22, 23 have a direct line of sight to both receivers 4, 5. FIG. 2 illustrates the broken line of sight 24 between the first receiver 4 and the formwork 25.

Therefore, when erecting formworks 2, the position of this formwork 25 will not be able to be determined from two determined distances if formwork 25 is erected after formwork 21. Rather, only the distance 26 to the reference point 3 with the second receiver 5 is known. Accordingly, only the radius 17 of this reference point 3 is shown in FIG. 3. Along this radius 17 or signal circle there are infinitely many theoretical position possibilities 25′, even in the known plane and within the construction site 10. For the sake of simplicity, this example assumes that the orientation information of the newly erected formwork 25 is available, so that the basic orientation (in the ground layout shown horizontally and parallel to the shorter side of the construction site 10) is known.

This is where the disclosed invention starts, which is based on the knowledge that the positions of the existing formworks 20, 21, 27 already erected before the fitted formwork 25 allow conclusions to be drawn about the probable position of the newly fitted formwork 25. In order to draw these conclusions, the position database 7 continuously stores the positions of the erected formworks 2 during the installation of the formwork 2, so that at the point in time shown in FIG. 3 the positions of the existing formwork 20, 21, 27 are stored in the position database 7. In addition, the formwork geometries of the existing formworks 20, 21, 27 are stored in the geometry database 8 (because they were received or associated during installation), and each position of a formwork stored in the position database 7 is linked to a geometry of the formwork in question. The adjustment unit 9 is set up for the determination of a fitting position 28 of the newly erected, fitted formwork 25 at one of the previously erected, existing formworks 20, 21, 27 and for storing the determined fitting position 28 in the position database 7 as the position of the fitted formwork 25 compatible with a distance determined by the distance determination unit 6 (corresponding to the radius 19 of radius 17). For this purpose, the adjustment unit is additionally connected to the geometry database 8 with the stored formwork geometries of the formworks and with the position database 7.

The boundary condition of fitting position 28 compatible with the determined distance is illustrated in more detail in FIGS. 4a and 4b. Of the three (but actually infinitely many) positioning options 25′ of the newly erected, fitted formwork 25, a position option 29 is already out of the question due to a collision with one of the existing formwork 20 and can be excluded. Such a collision can be detected on the basis of the positions and geometries of the existing formworks 20, 21, 27. A further position 30 would correspond to a gap and an offset (transverse to the formwork plane) between the next of the existing formworks 20 and the newly erected formwork 25. Under the assumption of basically adjacent formworks, in particular, if, due to the formwork geometry of the newly erected formwork a connection 31 (corresponding to fitting) on one or both sides with suitable connection surfaces 40 is required, this position option 30 can also be excluded. Therefore, exactly one position possibility, which is the fitting position 28 to the next of the existing formworks 20, can ultimately be determined as the most likely position of the newly erected formwork 25 and stored in the position database 7. In fitting position 28, a connection 31 is created by fitting two connection surfaces 40 adjacent formworks 20, 25. This stored position is associated, for example, with a reduced probability of 0.81 in order to map the uncertainty due to only one distance measurement used and because the position of the existing formwork 20, to which the fitted formwork 25 is fitted in the fitting position 28, is already itself a fitting position and was determined on the basis of only one distance (lack of line of sight to the receiver 4) and is therefore associated with a probability of 0.9 (0.81=0.9×0.9).

Without the orientation information, fitting positions can also be considered and compared with other orientations of the newly installed formwork, for example a vertical position of the newly erected formwork in the ground layout shown (i.e., parallel to the longer side of construction site 10). However, this would require a significantly smaller distance between the transmitter 11 and the reference point 3 so that it could also be excluded even without the orientation information due to the incompatibility with the determined distance (corresponds to radius 19).

A local zone boundary can cause fitting positions to be discarded. For example, for formwork 32 set up after formwork 25 (cf. FIG. 2), a fitting position below formwork 25 could be ruled out because the formwork would then exceed the boundary of construction site 10. The probability associated with this formwork 32 when using the fitting position at formwork 25 will be even less than 0.81, e.g., 0.73 (=0.81 times 0.9=0.9 to the power of 3), because it is the third fitting position in a row that uses only one distance measurement. For example, the probability limit value could be assumed to be 0.7 to ensure that at least every fourth formwork has a line of sight to at least two receivers so that the position can be determined.

When setting up formwork 33 (cf. FIG. 2), both receivers 4, 5 are (temporarily) received a locating signal, because this formwork 33 has a direct line of sight to both receivers 4, 5 when set up in the order described here. Both lines of sight are interrupted by formwork 22 as soon as it is set up. When setting up formwork 33, the position is determined on the basis of the determined distances to the two reference points 3 and the position of formwork 33 is again associated with a probability of one. Now it can be subsequently checked whether the formwork 32 has been positioned at a fitting position of the formwork 33 and, where applicable, the position of the formwork 32 has been corrected and associated with a higher probability (e.g., 0.9). The position of formwork 25 erected in front of formwork 32 could now be subsequently associated with a probability of 0.95 (square root of 0.9 plus 0.9), because this position is now confirmed by a distance and two fitting positions.

FIG. 5 shows the rear side of a formwork 2 more precisely, with a schematically shown transmitter 11. In this illustration, formwork 2 consists of a plywood core 37 with plastic covering, a plurality of frame profiles 38 made of aluminium and a bead 39 for the element connection. However, other materials for the formwork panel or frame profiles 38, as well as other connection options are also possible. In addition, all four circumferential surfaces are described as connection surfaces 40 (two visible, two hidden). This is due to the fact that another formwork can be fitted to all four connection surfaces 40, depending on the orientation of the formwork 2. In the embodiment shown, the connection surfaces 40 are graded in the middle, so that liquid concrete can drain into the resulting cavity in the event of leakage. However, other forms of connection surfaces 40, for example flat, are also possible. A transmitter 11 is centrally attached to the rear side of the formwork. This transmitter 11 is mounted exactly in the centre point of the formwork surface, i.e., at the intersection of the symmetry axes, so that measurement data of the gyroscope and/or magnetometer can be combined with the geometry data of formwork 2 as a basis for calculation and thus the exact position of the connection surfaces 40 can be determined. Another option not shown would be to place the transmitter 11 in a corner of the rear side of the formwork 2. A 3D magnetometer could thus be used to determine the exact position of formwork 2. A disadvantage here can be that a formwork 2 should preferably be rotated so that the transmitter 11 is as high up as possible and not at the bottom of the formwork 2, since here the probability is higher that the reception (LoS) is interrupted.

FIG. 6 shows three formworks 41, 42, 43 which are connected to each other. The connecting elements are not shown here. As connecting elements, conventional solutions known in the prior art such as quick clamps, tensioners, clamping terminals, clamps, fasteners, clamping locks, element connectors, for example, can be used. In addition to the two standing formworks 41, 42, a formwork 43 lying on it can also be seen. This formwork 43 is rotated by 90° compared to an upright formwork and fitted with the lateral connection surface 40 to the two frontal connection surfaces 40 of the standing formworks 41, 42. The fact that formwork 43 is rotated by 90° has already been detected by a gyroscope and/or a 3D magnetometer and/or an acceleration sensor. By detecting this position, the fitting positions 28 of this 90° rotated formwork 43 are updated and detected in the digital system.

FIG. 7a shows an already positioned formwork 44 and a corner element 45 in a position to be fitted and a subsequent formwork 46, i.e., to be fitted to the corner element at a later time. The formworks 44, 46 and corner element 45 are each equipped with a transmitter 11. The position of the corner element 45 cannot be clearly determined with the transmitter 11 alone and even with a magnetometer. For example, on a north-south straight line, mirrored position possibilities of the corner element 45 cannot be distinguished from each other (axis reflection/straight reflection). Although it is determined by the information “corner element” (i.e., the associated geometry of this special case of a formwork) that the position possibilities 47, 48, 49, 50 (more precise position and orientation possibilities) are at an angle of 90° to each other, it is not clear which of the four position possibilities 47-50 is the actual position of the corner element 45. The position options 48 and 50 with the connection surfaces 51 and 52 can be excluded due to the known connection surface 53 of the existing formwork 44. In order to also be able to exclude the position possibility 49 with the connection surface 54, it makes sense to wait for the position determination of the subsequent formwork 46 when using a simple magnetometer (position sensor). This can be represented digitally by a temporary connection geometry 55. The connection geometry 55 is shown slightly extended in FIG. 7a for clarity. Usually, the boundaries lie exactly on the formwork geometry, i.e., on the connection surfaces 54, 56 of the remaining position options 47, 49 (FIG. 7a shows the connection geometry 55 for easier traceability under the assumption that only one position option 47 is possible). A plurality of connection geometries 55 can also be displayed individually or combined in order to display the concrete position possibilities of the corner element 45 at least temporarily. As soon as the subsequent formwork 46 is fitted and further logical conclusions can be drawn about the position of the corner element 45, the connection geometry 55 is replaced by the well-known geometry of the corner element 45. The transmitter 11 is located in the shown embodiment in the corner area of the corner element 45. This has in particular space and structural reasons.

FIG. 7b basically shows a similar arrangement to FIG. 7a. The corner element 45 is shown here as a square connection geometry 55. Transmitters 11 at different attachment positions 57, 58 are also shown (in practice, typically only one transmitter is used at one attachment position). By fitting at least one subsequent formwork 46, the orientation of the corner element 45 can be concretized retrospectively, as shown in FIG. 7a. As can be seen from the shape of the connection geometry 55, the position options 48 and 50 were already excluded due to the connection surfaces 53 of the existing formwork 44 (the connection geometry 55 in accordance with FIG. 7b thus includes the two position options 47 and 49). The attachment position 58 of the transmitter 11 indicates in this example an ideal position at the corner element 45, since the position possibility in this case could also be excluded via the position of the transmitter 11, provided that the position determination of the transmitter 11 is precise enough.

FIG. 8 shows a formwork 59 fitted to an existing formwork 44 in a fitting position 28, wherein the fitted formwork 59 an arc element with four position options 60-63, the respective axis positions 60′-63′ per position 60-63, a digital connection geometry 64, a subsequent formwork 46 (drawn-in with dashes) and different transmitter positions 65-68 per position possibility 60-63 and depending on structural and/or positional reasons. Such a positional ground can be that the attachment of the transmitter 11 in a corner area is already directly at two points of the connection surfaces of the formwork 59, and thus forms a different, usually advantageous reference than a transmitter 11, which is, for example, attached off-centre, i.e., not at the intersection of the diagonals of the formwork surface. The position possibilities 62, 63 can be excluded here via the axis orientations 62′, 63′ (magnetometer, compass). However, the position option 61 has an essentially congruent axis orientation 61′ as the axis orientation 60′ of the position possibility 60 corresponding to fitting position 28. Depending on the geometry of the fitted formwork 59, position 61 may not be excluded with certainty via the axis position 61′. By detecting the subsequent formwork 46 and the associated connection surface 70, position 61 can be excluded at least retrospectively or a probable position determined on the basis of the assumed geometry of the fitted formwork (which would be the case, for example, with the arc element shown here) can be checked. Another possibility would be to position the transmitter 11 in such a way that a reflection or rotation of the formwork 59 (arc element) does not lead to the axis orientations being 60′, 61′ congruent. Examples of such transmitter positions 71-74 of transmitter 11 are shown in FIG. 8. In these examples, the transmitter 11 is arranged in the corner areas of a connection geometry 64 or in the intended centre point of the connection geometry 64.

1. A method for determining the position of a formwork fitted onto at least one existing formwork, comprising:
transmitting a locating signal from the fitted formwork;
receiving the transmitted locating signal with a receiver at least one reference point;
determining a distance between the fitted formwork and the at least one reference point based on the received locating signal;
determining a fitting position of the fitted formwork (25) on the at least one existing formwork compatible with the determined distance) on the basis of the formwork geometries of the fitted formwork and the at least one existing formwork, and
saving the determined fitting position as the position of the fitted formwork.

2. The method according to claim 1, wherein determining the fitting position comprises:
determining all possible fitting positions of the fitted formwork on the at least one existing formwork;
determining the associated distance of each determined possible fitting position to the at least one reference point;
determining those fitting positions as compatible with the determined distance whose associated distance is within a tolerance range around the determined distance.

3. The method according to claim 2, wherein determining the fitting position comprises:
limiting the possible fitting positions based on a local zone boundary.

4. The method according to claim 2, wherein determining the fitting position comprises:
limiting possible fitting positions on the basis of an orientation information concerning the fitted formwork.

5. The method according to claim 1, wherein a locating signal is transmitted together with a geometry of the fitted formwork and/or with an orientation information from the fitted formwork to a receiver.

6. The method for determining the position of a fitted formwork, comprising:
determining the number of reference points with a direct line of sight to the fitted formwork;
if the determined number of reference points is less than three or less than two, performing the method according to claim 1.

7. The method according to claim 6, wherein if the determined number of reference points is at least three, the position of the fitted formwork is determined on the basis of the distances to the at least three reference points and associated with a probability of one.

8. The method according to claim 6, wherein the position of the fitted formwork is associated with a reduced probability less than one, wherein the probability associated with the at least one existing formwork, to which the fitted formwork is fitted, is taken into account.

9. The method according to claim 8, wherein the reduced probability is determined as a function of a deviation of the determined distance from the distance corresponding to the stored fitting position.

10. The method according to claim 1, wherein determining the fitting position comprises:
determining a connection geometry for at least two positioning options;
determining the fitting position in the context of the position determination of a subsequent formwork, wherein the position of the subsequent formwork is determined at a fitting position compatible with the connection geometry.

11. The method according to claim 1, wherein the method is carried out on the basis of a stored installation sequence of a plurality of formworks and the respectively determined positions and/or distances, wherein, in the case of a plurality of possible fitting positions for a fitted formwork, the probability of the possible fitting positions is evaluated on the basis of other chronologically subsequently erected formworks and that of the possible fitting positions is determined as the position of the fitted formwork to which the greatest probability is associated.

12. A system for determining the position of formworks, comprising:
a fitted formwork with a transmitter for a locating signal,
at least one reference point with a receiver for a locating signal,
a distance determination unit set up to determine a distance between the fitted formwork and the at least one reference point based on a locating signal sent by the transmitter and received by the receiver;
a position database with stored positions of at least one existing formwork; and
an adjustment unit set up to determine a fitting position of the fitted formwork on an existing formwork compatible with a distance determined by the distance determination unit based on the formwork geometries of the fitted formwork and the at least one existing formwork, and to store the determined fitting positions in the position database as the position of the fitted formwork.

13. The system according to claim 12, wherein the adjustment unit is connected to a geometry database with stored formwork geometries of the fitted formwork and at least one existing formwork.

14. The system according to claim 12, wherein the transmitter is centred on the fitted formwork.

15. The system according to claim 12, wherein the fitted formwork (25) comprises an orientation sensor, wherein the orientation sensor is connected to the transmitter.
